(19) United States
(12) Patent Application Publication
(10) Pub. No.: US 2002/0017770 A1
(43) Pub. Date: Feb. 14, 2002

(54) Trailer rack rack

(76) Inventor: Rob G. Parrish, Bellaire, TX (US)

Correspondence Address: Gordon T Arnold, Arnold & Associates, 2603 Augusta, Suite 800, Houston, TX, 77057, US

(21) Appl. No.: 09/501,793

(22) Filed: Feb. 10, 2000

(51) Int. Cl. B60D 1/167

(52) U.S. Cl. 280/480.1; 280/491.1; 280/491.3; 280/491.5

(57) ABSTRACT

The present invention discloses a receptacle mounted at a predetermined location for storing various tow hitch apparatuses and assemblies. Behind the mounting surface, the area may be hollow such as a standard dwelling wall or solid such as a brick or concrete wall found in a basement. Furthermore, the invention may be mounted on a floor or wall of a vehicle storage compartment. The dimensions of the invention are such that it can in one embodiment receive the standard two inch male connector and in other embodiments receive other standard male portions of a tow hitch apparatus. In particular, the invention is designed to receive the various racks that have become popular for carrying sports equipment. These rigid racks attach to the standard trailer hitch receptacle found on many vehicles.

### BACKGROUND OF THE INVENTION

1. Field of Invention

The present invention relates generally to devices used to store trailer hitch apparatuses and assemblies, which are collectively referred to as “trailer hitch apparatuses” herein. More specifically, the present invention relates to the storage of various trailer hitch apparatuses, which are designed to be attached to a vehicle's tow hitch. Mounted on a stationary object, the present invention further allows various trailer hitch apparatuses that are designed for use with moving vehicles to become functional as a stationary storage device.

2. General Background

Tow hitch apparatuses and tow hitch assemblies normally attach to a vehicle's trailer hitch. Tow hitch apparatuses, such as racks, are generally used for carrying sports equipment, e.g. bike racks, ski racks, and snowboard racks. Tow hitch apparatuses attach to vehicles by inserting into a standard 1¼″ or 2″ receiver hitch or a nonstandard receiver hitch. When a tow hitch apparatus is not attached to a vehicle, the present state of the art stores the tow hitch apparatus by relegating the apparatus to a corner of some storage place. Such stowage is cumbersome and prevents further use of the stored trailer hitch apparatus.

It is an object of the present invention to provide a device, method and means for storage of various trailer hitch apparatuses onto a substantially stationary object having a substantially flat surface, e.g. a wall or vehicle storage compartment. Further, it is an object of the present invention to extend the use of a stored trailer hitch apparatus to a stationary storage device. A stored and stationery trailer hitch apparatus may support the items that the apparatus supports in conventional usage or support various and sundry items.

Tow hitch assemblies are commonly used to attach one vehicle with another vehicle. Numerous designs of tow hitch assemblies are used to facilitate the towing of various trailers. Moreover, many vehicles carry several tow hitch assemblies in order to accommodate the size and strength requirements for towing. When a tow hitch assembly is not attached to a vehicle, the present state of the art stores the tow hitch assembly by placing the assembly in a vehicle's trunk, or relegating the assembly to a corner of some storage place. It is, therefore, an object of another embodiment of the present invention to provide a method and means for storage of various trailer hitch assemblies by mounting the invention to the floor of a vehicle storage compartment.

Unless otherwise specified, the term “trailer hitch apparatus” is understood to include “trailer hitch assemblies.”

### SUMMARY OF THE INVENTION

The present invention is a device, method and means for storage of tow hitch apparatuses and assemblies. The term “trailer hitch apparatus” as used herein, is understood to include both trailer hitch apparatuses and assemblies unless otherwise specified. Trailer hitch apparatuses are designed to fit trailer receiver hitches, and transport equipment while attached to a trailer receiver hitch. Furthermore, the present invention is designed to extend the functional nature of trailer hitch apparatuses. While the trailer hitch apparatuses are inserted into the present invention, these apparatuses can store the same equipment that the apparatus normally carries. Finally, mounting the present invention to a vehicle storage compartment permits the storage of various trailer hitch apparatuses.

According to one aspect of the invention, a device is provided for storing a trailer hitch apparatus at a predetermined storage location, having a male trailer hitch mounting member positioned for mating with a female connector, wherein the female connector is mounted to a vehicle, the device comprising a mounting portion and a trailer hitch mounting portion receptacle, connected to the mounting member.

According to another aspect of the invention, a method is provided for storing a trailer hitch apparatus at a predetermined storage location, having a male trailer hitch mounting member positioned for mating with a vehicle receptacle mounted to a vehicle, the method comprising receiving the male trailer hitch mounting member into the receptacle, the receptacle being connected to the storage location, and limiting reciprocation between the male trailer hitch mounting member and the receptacle.

According to still another aspect of the invention, a system is provided for storing a trailer hitch apparatus at a predetermined storage location, having a male trailer hitch mounting member positioned for mating with a female connector, wherein the female connector is mounted to a vehicle, the system comprising a receptacle, connected to the storage location and arranged for receiving the male trailer hitch mounting member, and means for limiting reciprocation between the male trailer hitch mounting member and the receptacle.

According to another aspect of the invention, a storage compartment is provided for a vehicle having a receptacle for holding a trailer hitch mounting apparatus having a male trailer hitch mounting member, the storage compartment comprising a mounting portion connected to the storage compartment, and a trailer hitch mounting portion receptacle, connected to the mounting portion.

### BRIEF DESCRIPTION OF THE DRAWINGS

FIG. 1 is a side view of a vehicle having a receptacle for a trailer hitch apparatus.

FIG. 2 is a device comprising a trailer hitch mounting portion receptacle, which mates with a trailer hitch apparatus.

FIG. 3 is a side view of a vehicle having a storage compartment and a receptacle for a trailer hitch apparatus.

FIGS. 4a and 4b are side views of a truck bed having a vehicle storage compartment and a trailer hitch mounting portion receptacle.

FIG. 5 is a side view of a trailer hitch mounting portion receptacle ready to mate with a male trailer hitch mounting member, which is secured by a threaded bolt.

FIG. 6 is a side view of a trailer hitch mounting portion receptacle ready to mate with a male trailer hitch mounting member, which is secured by a pin.

FIG. 7 is a side view of a trailer hitch mounting portion receptacle ready to threadedly mate with a male trailer hitch mounting member.

FIG. 8 is a side view of a trailer hitch mounting portion receptacle ready to mate with a male trailer hitch mounting member, which is frictionally secured by an o-ring.

FIG. 9 is a side view of a trailer hitch mounting portion receptacle ready to mate with a male trailer hitch mounting member, which is frictionally secured by a tab.

FIGS. 10a and 10b are side views of a trailer hitch mounting portion receptacle, which is pivotally secured to the mounting portion by sliding a pin through both the holes in the tabs and the receptacle.

FIG. 11 is a side view of mounting cylinders ready to secure the mounting portion.

FIG. 12 is a side view of the mounting portion placed behind a retaining structure, which includes an opening through which the receptacle passes.

FIG. 13 is a side view of a trailer hitch mounting portion receptacle ready to mate with a male trailer hitch mounting member, which is secured by a threaded bolt and nut.

FIG. 14 is a side view of a trailer hitch mounting portion receptacle ready to mate with a male trailer hitch mounting member, which is secured by a cotter pin.

### DETAILED DESCRIPTION OF EXAMPLE EMBODIMENTS OF THE INVENTION

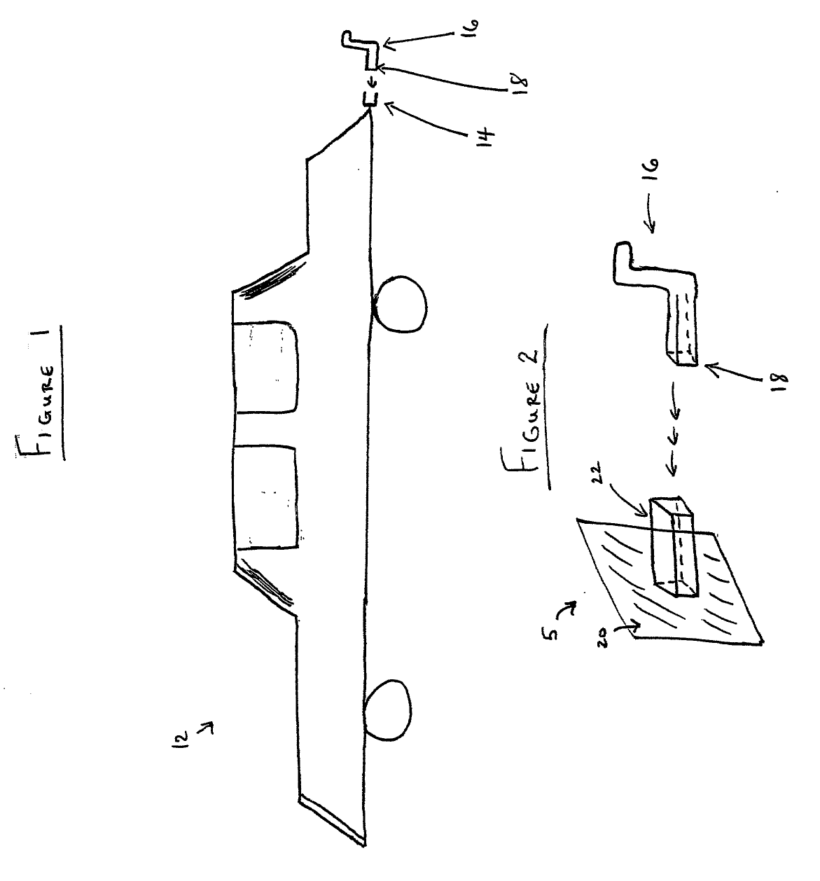

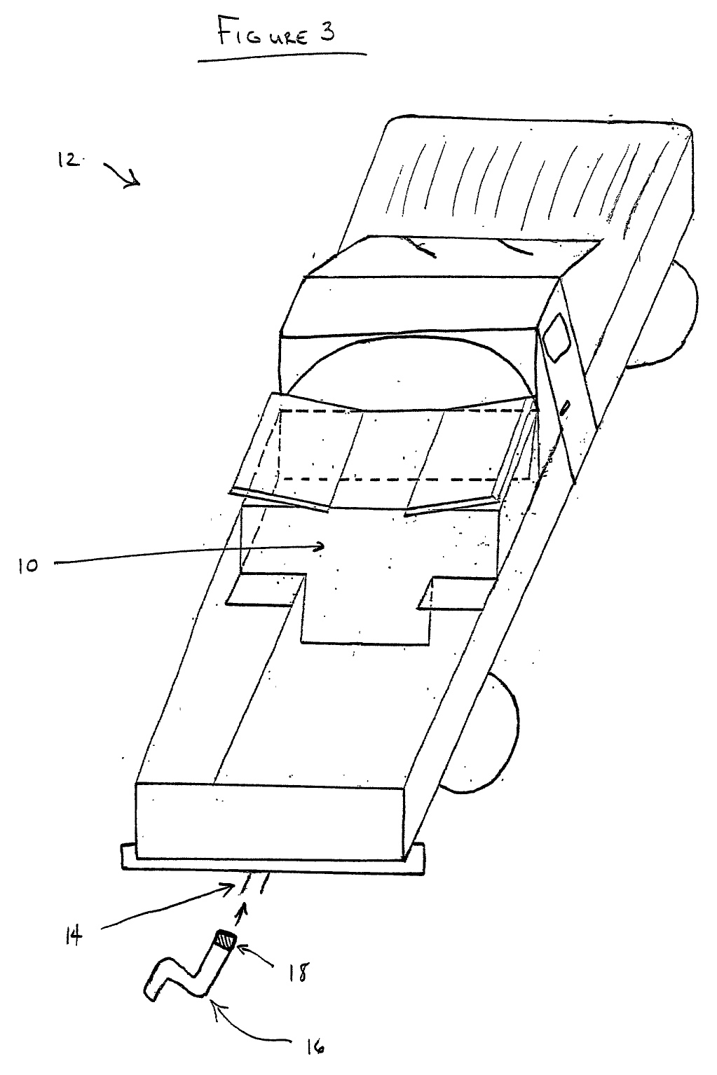

According to one aspect of the invention, a device 5 for storing a trailer hitch apparatus is presented. Referring now to FIGS. 1 and 2, the Figures show a device 5 for storing a trailer hitch apparatus 16 at a predetermined storage location, having a male trailer hitch mounting member 18 positioned for mating with a female connector 14, wherein female connector 14 is mounted to a vehicle 12, comprising a mounting portion 20 and a trailer hitch mounting portion receptacle 22, which is connected to mounting portion 20.

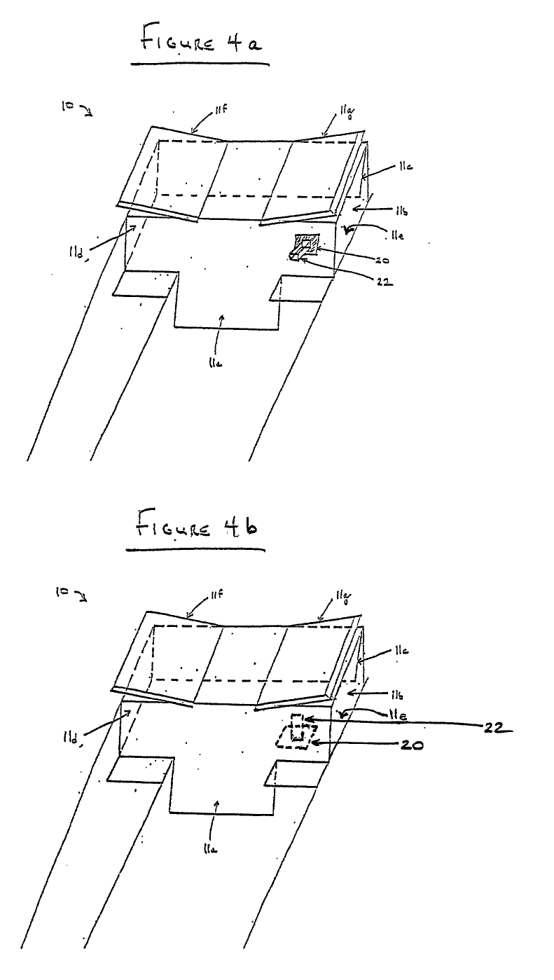

Referring now to FIG. 3, a storage compartment 10 is seen for a vehicle 12 having a receptacle 14 for holding a trailer hitch mounting apparatus 16 having a male trailer hitch mounting member 18. Referring now to FIG. 4a, an example structure of storage compartment 10, having walls 11a-11d, bottom lie, and lids 11f and 11g is seen, which is similar to storage compartments widely used in pick-up trucks, as are commonly known in the art. According to this illustration of the invention, and unlike prior art storage compartments, storage compartment 10 comprises: a mounting portion 20 connected to storage compartment 10, a trailer hitch mounting portion receptacle 22, connected to mounting portion 20. In some embodiments, mounting portion 20 is integrally formed with a wall 11a of storage compartment 10. In other embodiments, mounting portion 20 is connected to a wall 11a of storage compartment 10, by, for example, bolting, welding, riveting, and any other method that will occur to those of skill in the art without further elaboration. It should also be noted that, although, storage compartment 10 has a particular shape, having two lids, as is common in prior art compartments, the present invention is not limited by the shape or number of lids of the storage compartment. Furthermore, it should be noted that the present invention is not limited by mounting portion's 20 locus of connection to storage compartment 10. In still a further embodiment, as seen in FIG. 4b, mounting portion 20 is connected not to a wall 11a-11d, but inside storage compartment 10 to bottom lie. Other storage compartment shapes and lid arrangements, including no lid at all, will occur to those of skill in the art without departing from the disclosed invention.

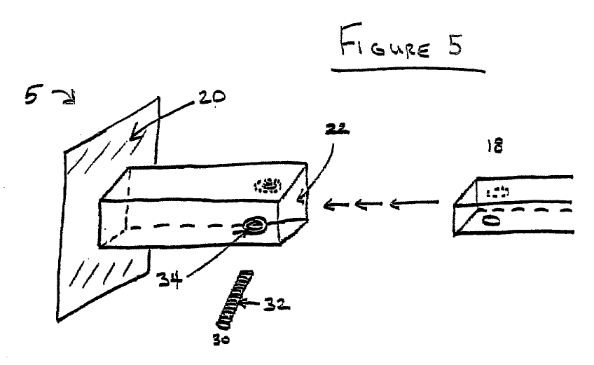

Referring now to FIG. 5, in a further embodiment of the invention, block 30 is positioned for insertion through at least a portion of receptacle 22 and for engagement with male trailer hitch mounting member 18. In FIG. 5, block 30 engages male trailer hitch mounting member 18 binding it, and comprises a bolt having block threads 32 engaging receptacle threads 34. In still a further embodiment, seen in FIG. 6, block 30 comprises pin 36, inserted through holes 22a and 22b in receptacle 22 and holes 18a and 18b in member 18. In some embodiments, receptacle 22 and member 18 are arranged wherein block 30 is inserted through only hole 22a and hole 18a.

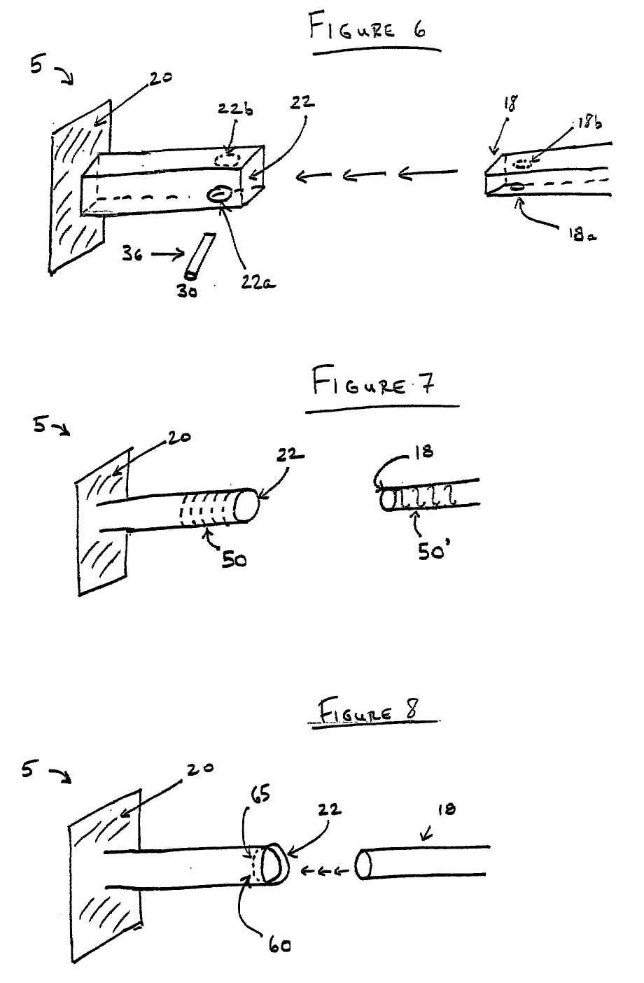

Referring now to FIG. 7, according to further embodiments of the invention, threads 50 are positioned inside receptacle 22 for engagement with member 18. According to one such embodiment, as seen in the Figure, male trailer hitch mounting member 18 includes threads 50′ adapted for threaded engagement with threads 50. According to an alternative embodiment, member 50 includes no such threads, and reciprocation between receptacle 22 and member 18 is limited through friction.

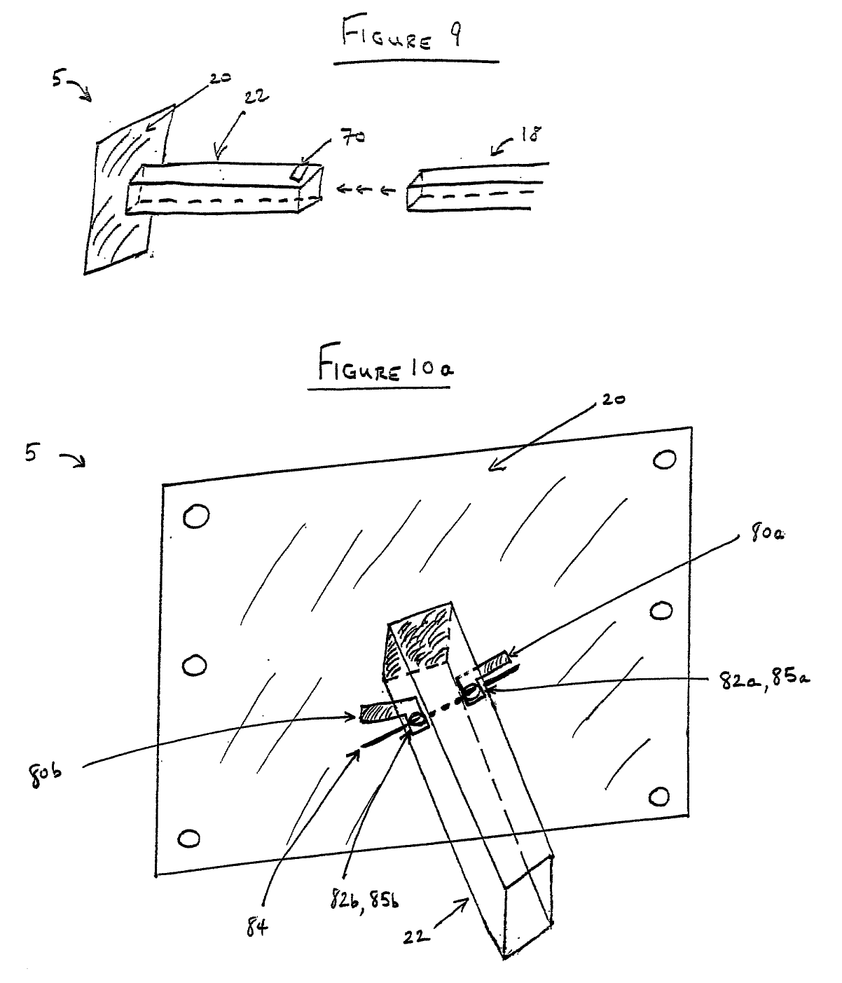

Referring now to FIG. 8, in yet another embodiment of the invention, receptacle 22 includes friction member 60, an example of which is an o-ring 65 as seen in the Figure, having less hardness than male trailer hitch mounting member 18, and preferably being of an elastomeric material. In FIG. 9, another example friction member is seen, comprising tab 70. As seen, tab 70 is connected to at least one side of receptacle 22, and is, in this embodiment, softer than male trailer hitch mounting member 18. Other friction members will occur to those of skill in the art of various shapes and materials to cause resistance to reciprocation between male trailer hitch mounting member 18 and receptacle 22 without departing from the spirit of the present invention.

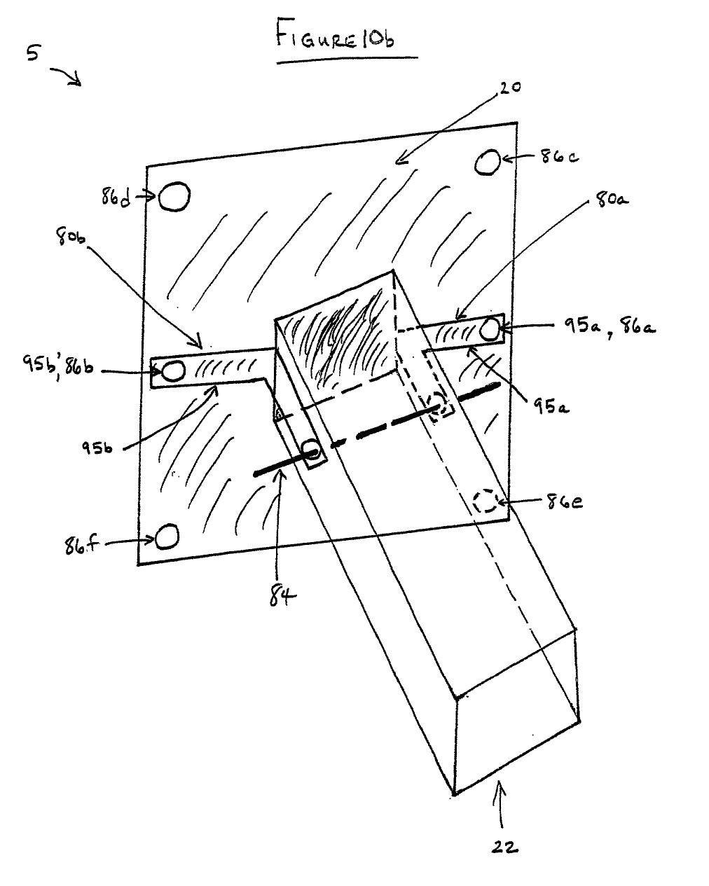

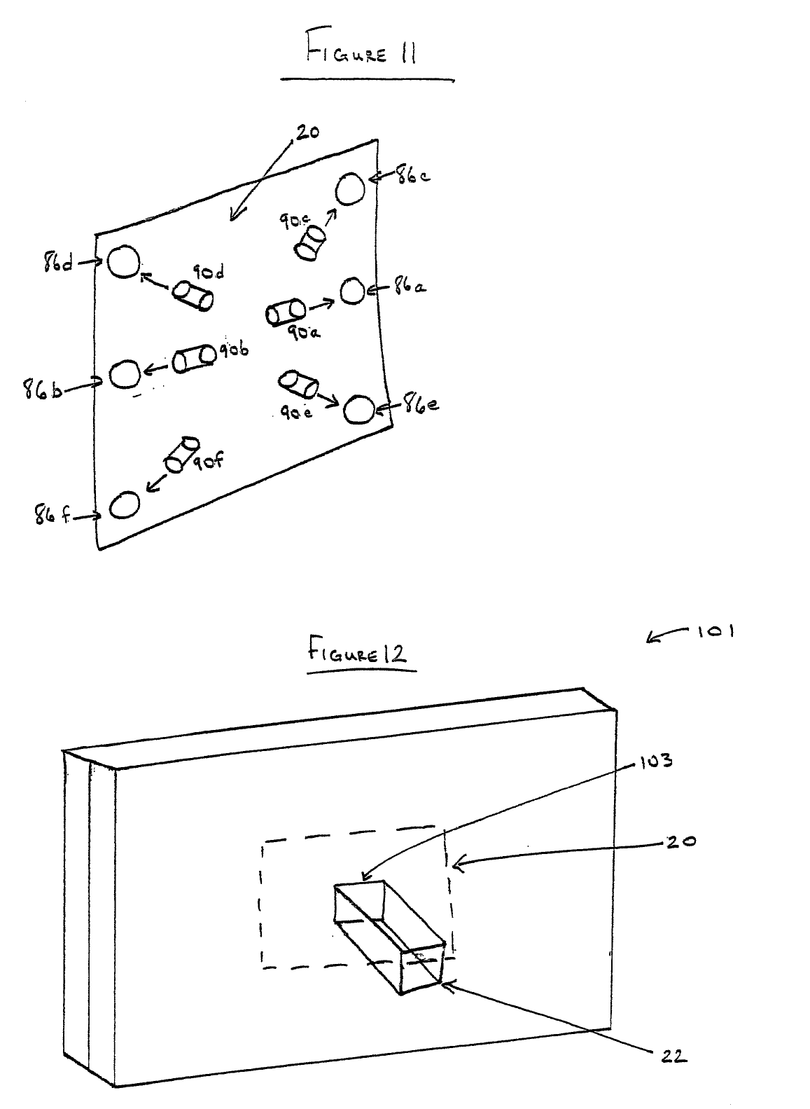

It will be noted in reference to the preceding figures that mounting portion 20 is seen in a fixed relation to receptacle 22. In some embodiments, mounting portion 20 is connected to receptacle 22 by a weld. In other embodiments, mounting portion 20 is integrally formed with receptacle 22 by many means that are commonly known (for example, casting, forging, etc.). In alternative embodiments, however, mounting portion 20 is movably connected to receptacle 22, as seen, for example, in FIG. 10a, where a pivotal attachment is seen. Various means for achieving a pivotal connection will occur to those of skill in the art without departing from the spirit of the invention. In the non-limiting example of FIG. 10a, mounting portion 20 includes tabs 80a and 80b, each of which are integrally formed to and extend from mounting portion 20 (here at about 90 degrees, but at any convenient angle in alternative embodiments). Holes 82a and 82b are provided in receptacle 22, which are engaged by pin 84, slid through holes 85a and 85b in tabs 80a and 80b, respectively. In an alternative and non-limiting example, tabs 80a and 80b are connected to mounting portion 20, by, for example, bolting, welding, riveting, and any other method that will occur to those of skill in the art. In still another alternative embodiment, as seen in FIG. 10b, flange 95a of tab 80a and flange 95b of tab 80b are connected to mounting portion 20 by, for example, mounting cylinders 90a-90f (as seen in FIG. 11), which traverse flange holes 95a′ and 95b′ and at least two of bolt holes 86a-86f found in mounting portion 20.

It will also be noted that, in the preceding Figures, mounting portion 20 is a substantially flat member. In other embodiments of the invention, whether for device 5 or storage compartment 10 embodiments, mounting portion 20 is curved, for example, convex or concave, depending on the surface to which mounting portion 20 is to be connected. For example, in some embodiments, mounting portion 20 is connected to a garage wall or, alternatively, the wall of a dwelling or storage warehouse. Various methods for attaching mounting portion 20 will occur to those of skill in the art without departing from the sprit of the invention. In some embodiments, for example, mounting portion 20 includes bolt holes 86a-86f (FIG. 10b). In an alternative embodiment, seen in FIG. 11, mounting portion 20 includes mounting cylinders 90a-90f (for example, pins, bolts, etc.). In some embodiments, mounting cylinders 90a-90f are threadedly connected to mounting portion 20. In even further embodiments, mounting cylinders 90a-90f are welded to mounting portion 20, while, in still other embodiments, mounting cylinders 90a-90f are integrally formed with mounting portion 20, by, for example, casting, forging, or other methods that will occur to those of skill in the art.

In still a further embodiment, as seen in FIG. 12, mounting portion 20 is placed behind a retaining structure 101, which includes an opening 103 through which receptacle 22 passes.

Much of the description above relates to the use of mounting portion 20 and receptacle 22 in combination with a storage compartment 10 or as a device 5 for storing a trailer hitch apparatus 16. However, according to still a further aspect of the invention, a device 5 is provided comprising mounting portion 20 and receptacle 22, made, positioned, and arranged as described above. In use, according to a further aspect of the invention, a method is provided for storing a trailer hitch apparatus 16 (FIGS. 1, 3) at a predetermined storage location, having a male trailer hitch mounting member 18 positioned for mating with a vehicle receptacle 14 mounted to a vehicle 12. According to the present embodiment, the method comprises: receiving the male trailer hitch mounting member 18 into receptacle 22, receptacle 22 being connected to the storage location (for example, the interior wall of a garage or storage warehouse), and limiting reciprocation between male trailer hitch mounting member 18 and receptacle 22.

In addition, according to still a further aspect of the invention, a system is provided for storing a trailer hitch apparatus 16 (FIGS. 1, 3) at a predetermined storage location, having a male trailer hitch mounting member 18 positioned for mating with a female connector 14, wherein female connector 14 is mounted to a vehicle 12. According to the present embodiment, the system comprises: a receptacle 22 connected to the storage location and arranged for receiving male trailer hitch mounting member 18, and a means for limiting reciprocation between male trailer hitch mounting member 18 and receptacle 22.

According to still a further embodiment of the invention as seen in FIG. 6, the limiting of reciprocation comprises accepting a blocking member 30 through at least a portion of the male trailer hitch mounting member 18 and through at least a portion of receptacle 22. FIG. 6 depicts a method and means for engaging and binding male trailer hitch mounting member 18 with receptacle 22, which is accomplished by inserting blocking member 30 through one or both holes 22a and 22b of receptacle 22 and one or both holes 18a and 18b of male trailer hitch mounting member 18. It should be noted that various methods and means for limiting the reciprocation between male trailer hitch mounting member 18 and trailer hitch mounting portion receptacle 22 are possible without departing from the spirit of the present invention.

Referring now to FIG. 7, another method and means for limiting the reciprocation comprises connecting male trailer hitch mounting member 18 and receptacle 22 in a threaded engagement. In the Figure, threads 50′ of male trailer hitch mounting member 18 provide a method and means to engage threads 50 of receptacle 22. In an alternative embodiment, neither male trailer hitch mounting member 18 nor receptacle 22 contain threads 50′ and 50, respectively, and the method and means for reciprocation between male trailer hitch mounting member 18 and receptacle 22 is limited to friction. In still another alternative embodiment, a method and means for limiting reciprocation comprises connecting male trailer hitch mounting member 18 and receptacle 22 in a friction fit. In FIGS. 8 and 9, use of friction member 60, examples of which are an o-ring 65 and tab 70, respectively, is the means that causes increased resistance, which more securely binds male trailer hitch mounting member 18 and receptacle 22. Other methods and means for limiting reciprocation vis-à-vis friction between receptacle 22 and male trailer hitch mounting member 18 will occur to those of skill and the art, which do not depart from the spirit of the present invention.

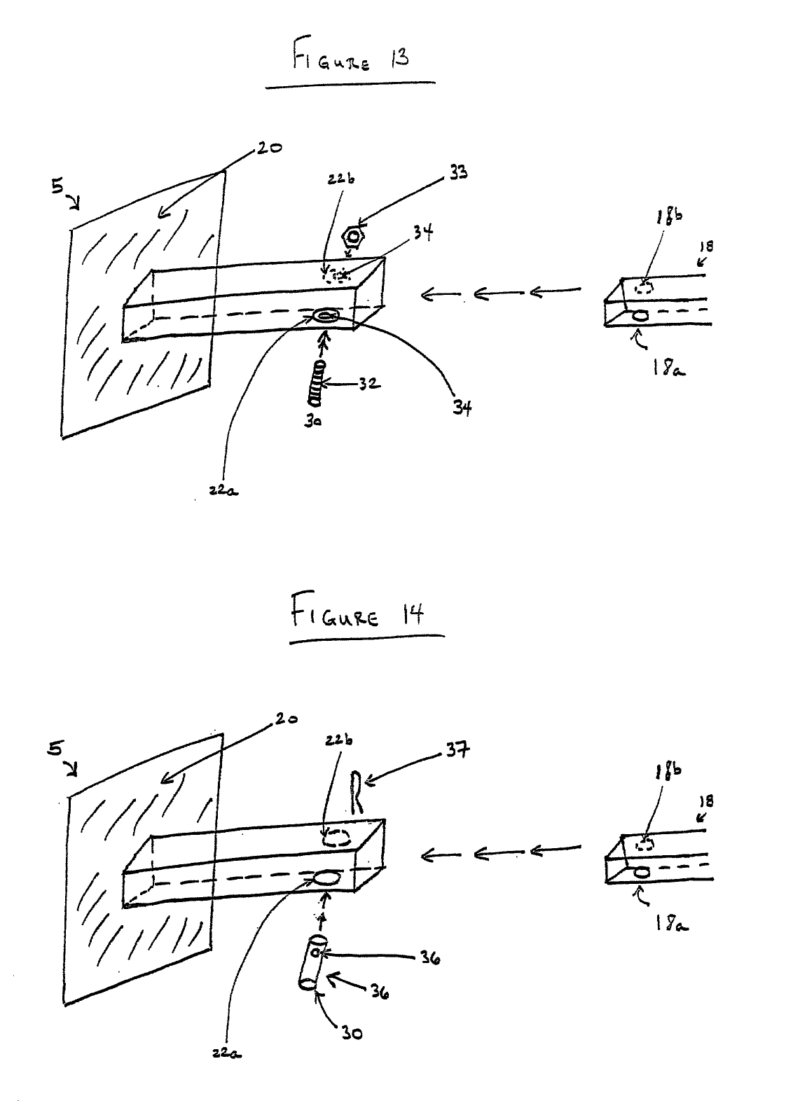

Referring now to FIG. 5, the Figure illustrates a method and means for securing blocking member 30 into the blocking position. In FIG. 5, a method and means for securing blocking member 30 into the blocking position is accomplished by inserting male trailer hitch mounting member 18 into receptacle 22, and engaging threads 32 of blocking member 30 with receptacle threads 34. In an alternative embodiment, as seen in FIG. 13, blocking member's threads 32 are secured with threaded nut 33, comprising hexagonal, lock, and wing nuts. Nut 33 supplies the means for securing blocking member 30 into the blocking position.

Referring now to FIG. 14, in still another embodiment, blocking member 30 comprises pin 36, which produces the blocking position. Pin 36 is inserted through holes 22a, 18a, 18b, and 22b, thereby mating receptacle 22 with male trailer hitch mounting member 18, and cotter pin 37 engages hole 36′ in pin 36. Like nut 30 in FIG. 13, cotter pin 37 is the means for securing blocking member 30 into the blocking position. Other methods and means for securing blocking member 30 into the blocking position, such as clamping, fastening, and pinching, will occur to those of skill and the art without departing from the spirit of the present invention.

Having thus described an exemplary embodiments of the invention, it will be apparent that various alterations, modifications and improvements will readily occur to those skilled in the art. Such obvious alterations, modifications and improvements, though not expressly described above, are nevertheless intended to be implied and are within the spirit and scope of the invention. Accordingly, the foregoing discussion is intended to be illustrative only, and not limiting; the invention is limited and defined by the following claims and equivalents thereto.

What is claimed is:

1. A device for storing a trailer hitch apparatus at a predetermined storage location, having a male trailer hitch mounting member positioned for mating with a female connector, wherein the female connector is mounted to a vehicle, the device comprising:
a mounting portion; and
a trailer hitch mounting portion receptacle, connected to the mounting portion.

2. A device as in claim 1 further comprising a block positioned for insertion through at least a portion of the receptacle and for engagement with the mounting member.

3. A device as in claim 2 further comprising a block positioned for insertion through all of the receptacle and for engagement with the mounting member.

4. A device as in claim 1 further comprising a friction member connected to the receptacle.

5. A device as in claim 1 further comprising threads positioned to engage the mounting member.

6. A device as in claim 1 wherein said mounting portion is fixed to the trailer hitch mounting portion receptacle.

7. A device as in claim 1 wherein said mounting portion is movably attached to the trailer hitch mounting portion receptacle.

8. A device as in claim 7 wherein said mounting portion is pivotally attached to the trailer hitch mounting portion receptacle.

9. A device as in claim 1 wherein said mounting portion comprises a substantially flat member.

10. A device as in claim 9 wherein said mounting portion further includes mounting holes therein.

11. A device as in claim 9 wherein said mounting portion further includes mounting cylinders connected thereto.

12. A device as in claim 11 wherein said mounting cylinders comprise bolts.

13. A device as in claim 12 wherein said bolts are threadedly connected to the mounting portion.

14. A device as in claim 12 wherein said bolts are integrally connected to the mounting portion.

15. A device as in claim 14 wherein said bolts are welded to said mounting portion.

16. A device as in claim 11 wherein said mounting cylinders comprise pins.

17. A device as in claim 16 wherein said pins are threadedly connected to the mounting portion.

18. A device as in claim 16 wherein said pins are integrally connected to the mounting portion.

19. A device as in claim 18 wherein said pins are welded to said mounting portion.

20. A device as in claim 18 wherein said pins are cast with said mounting portion.

21. A method for storing a trailer hitch apparatus at a predetermined storage location, having a male trailer hitch mounting member positioned for mating with a vehicle receptacle mounted to a vehicle, the method comprising:
receiving the member into the receptacle, the receptacle being connected to the storage location, and
limiting reciprocation between the member and the receptacle.

22. A method as in claim 21, wherein said limiting comprises accepting a blocking member through at least a portion of the mounting member and through at least a portion of the receptacle.

23. A method as in claim 22 wherein said limiting further comprises accepting the blocking member through all of the mounting member.

24. A method as in claim 22 wherein said limiting further comprises accepting the blocking member through all of the receptacle.

25. A method as in claim 24 wherein said limiting further comprises accepting the blocking member through all of the mounting member.

26. A method as in claim 22 further comprising securing the blocking member in a blocking position.

27. A method as in claim 21 wherein said limiting comprises connecting the mounting member and the receptacle in a friction fit.

28. A method as in claim 21 wherein said limiting comprises connecting the mounting member and the receptacle in a threaded engagement.

29. A system for storing a trailer hitch apparatus at a predetermined storage location, having a male trailer hitch mounting member positioned for mating with a female connector, wherein the female connector is mounted to a vehicle, the system comprising:
a receptacle, connected to the storage location and arranged for receiving the mounting member; and
means for limiting reciprocation between the mounting member and the receptacle.

30. A system as in claim 29 wherein said means for limiting comprises means for accepting a blocking member through at least a portion of the mounting member and through at least a portion of the receptacle.

31. A system as in claim 30 wherein said means for limiting further comprises means for accepting the blocking member through all of the mounting member.

32. A system as in claim 30 wherein said means for limiting further comprises means for accepting the blocking member through all of the receptacle.

33. A system as in claim 32 wherein said means for limiting further comprises means for accepting the blocking member through all of the mounting member.

34. A system as in claim 30 further comprising means for securing the blocking member in a blocking position.

35. A system as in claim 29 wherein said means for limiting comprises means for connecting the mounting member and the receptacle in a friction fit.

36. A system as in claim 29 wherein said means for limiting comprises means for connecting the mounting member and the receptacle in a threaded engagement.

37. A storage compartment for a vehicle having a receptacle for holding a trailer hitch mounting apparatus having a male trailer hitch mounting member, the storage compartment comprising:
a mounting portion connected to the storage compartment; and
a trailer hitch mounting portion receptacle, connected to the mounting portion.

38. A storage compartment as in claim 37 further comprising a block positioned for insertion through at least a portion of the receptacle and for engagement with the mounting member.

39. A storage compartment as in claim 38 further comprising a block positioned for insertion through all of the receptacle and for engagement with the mounting member.

40. A storage compartment as in claim 37 further comprising a friction member connected to the receptacle.

41. A storage compartment as in claim 37 further comprising threads positioned in the receptacle to engage the mounting member.

42. A storage compartment as in claim 37 wherein said mounting portion is fixed to the trailer hitch mounting portion receptacle.

43. A storage compartment as in claim 37 wherein said mounting portion is movably attached to the trailer hitch mounting portion receptacle.

44. A storage compartment as in claim 43 wherein said mounting portion is pivotally attached to the trailer hitch mounting portion receptacle.

45. A storage compartment as in claim 37 wherein said mounting portion comprises a substantially flat member.

46. A storage compartment as in claim 45 wherein said mounting portion further includes mounting holes therein.

47. A storage compartment as in claim 45 wherein said mounting portion further includes mounting cylinders connected thereto.

48. A storage compartment as in claim 47 wherein said mounting cylinders comprise bolts.

49. A storage compartment as in claim 48 wherein said bolts are threadedly connected to said mounting portion.

50. A storage compartment as in claim 48 wherein said bolts are integrally connected to said mounting portion.

51. A storage compartment as in claim 50 wherein said bolts are welded to said mounting portion.

52. A storage compartment as in claim 47 wherein said mounting cylinders comprise pins.

53. A storage compartment as in claim 52 wherein said pins are threadedly connected to said mounting portion.

54. A storage compartment as in claim 52 wherein said pins are integrally connected to said mounting portion.

55. A storage compartment as in claim 54 wherein said pins are welded to said mounting portion.

56. A storage compartment as in claim 54 wherein said pins are cast with said mounting portion.

57. A storage compartment as in claim 37 wherein said mounting portion is integrally formed with a wall of the storage compartment.

58. A storage compartment as in claim 37 wherein said mounting portion is connected to a wall of the storage compartment.
